(19) United States
(12) Patent Application Publication
(10) Pub. No.: US 2015/0016208 A1
(43) Pub. Date: Jan. 15, 2015

(54) MULTI-CHAMBER CONTAINER FOR STORING AND MIXING LIQUIDS

(71) Applicant: Solutions BioMed, LLC, Orem, UT (US)

(72) Inventors: Brian G. Larson, Alpine, UT (US); Jonathan George, Lehi, UT (US)

(21) Appl. No.: 13/942,041

(22) Filed: Jul. 15, 2013

(51) Int. Cl. B65D 25/08; B01F 13/00; B65D 81/32

(52) U.S. Cl. CPC B65D 25/08; B65D 81/32; B01F 13/0023
USPC 366/130; 222/83; 206/222

(57) ABSTRACT

The present disclosure is drawn to a multi-chamber container and related methods for storing and mixing liquids and associated methods of use. The multi-chamber container includes a first chamber configured to contain a first liquid composition. The multi-chamber container also includes a second chamber configured to contain a second liquid composition. The multi-chamber container further includes a barrier operable to separate the first chamber and the second chamber. Additionally, the multi-chamber container includes a compliant mechanism movable between a first position and a second position and a plunger movable with the compliant mechanism to alter or remove the barrier. In the first position, the barrier is operable to maintain the first liquid composition and the second liquid composition separate from one another. In the second position, the plunger is operable to alter or remove the barrier to facilitate contact of the first liquid composition and the second liquid composition.

### BACKGROUND

Many compositions are made of two or more components which are not mixed together until shortly before use of the compositions. For example, some disinfectant or cleaning compositions include two or more components. In many such cases, at least one of the components can have a reduced chemical stability when diluted or some other reduced shelf-life once combined into the final compositions. Therefore, it can be beneficial to package some compositions as separate components in multi-component systems which can be combined shortly before use. Typically, individual components in a multi-component system are packaged at higher concentration, and then are manually combined in a final combined composition.

### BRIEF DESCRIPTION OF DRAWINGS

FIGS. 1A and 1B are cross-sectional schematic views of a multi-chamber container for storing and mixing liquids, in accordance with an embodiment of the present disclosure.

FIGS. 2A and 2B are cross-sectional schematic views of a multi-chamber container for storing and mixing liquids, in accordance with another embodiment of the present disclosure.

FIG. 3 is cross-sectional schematic view of an insert module for a container for storing and mixing liquids, in accordance with an embodiment of the present disclosure.

FIG. 4A is cross-sectional schematic view of an insert module for a container for storing and mixing liquids, in accordance with another embodiment of the present disclosure.

FIG. 4B is a top view of the insert module of FIG. 4A.

FIG. 5 is a cross-sectional schematic view of a multi-chamber container for storing and mixing liquids including the insert module of FIGS. 4A and 4B, in accordance with a further embodiment of the present disclosure.

FIGS. 6A-7 are perspective views of an insert module for a container for storing and mixing liquids, in accordance with yet another embodiment of the present disclosure.

FIG. 8 is a cross-sectional view of the insert module of FIGS. 6A-7.

FIG. 9 is an exploded view of an insert module for a container for storing and mixing liquids, in accordance with still another embodiment of the present disclosure.

FIG. 10 is a cross-sectional view of the insert module of FIG. 9.

FIGS. 11A-11C are cross-sectional schematic views of a stopper barrier of a multi-chamber container for storing and mixing liquids, in accordance with an embodiment of the present disclosure.

### DETAILED DESCRIPTION

Reference will now be made to the exemplary embodiments, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. It is also to be understood that the terminology used herein is used for the purpose of describing particular embodiments only. The terms are not intended to be limiting unless specified as such.

It must be noted that, as used in this specification and the appended claims, the singular forms “a,” “an,” and “the” include plural referents unless the content clearly dictates otherwise.

The term “multi-part” when referring to a container or system of the present disclosure is not limited to containers or systems having only two or three parts. For example, a system can have any number of liquids (solutions, suspensions, or dispersions, for example) present in a single system.

The term “colloidal transition metals” refers to colloidal particles of elemental transitional metals or the alloys of such elemental transition metals. Colloidal transition metals are distinct from salts and oxides of transition metals. Accordingly, compounds such as silver oxide, silver nitrate, silver chloride, silver bromide, silver iodide, and the like are not colloidal transition metals.

In describing embodiments of the present invention, reference will be made to “first” or “second” as they relate to chambers, compartments, or liquid compositions, etc. It is noted that these are merely relative terms, and a chamber or composition described or shown as a “first” chamber or composition could just as easily be referred to a “second” chamber or composition, and such description is implicitly included herein.

Discussion of liquids or fluids herein does not require that each component be completely liquid. For example, a liquid or fluid can be a solution or even a suspension. Thus, a colloidal metal-containing liquid or fluid is considered to be a liquid or fluid as defined herein.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

In accordance with these definitions and embodiments of the present disclosure, a discussion of the various systems and methods is provided including details associated therewith. This being said, it should be noted that various embodiments will be discussed as they relate to the systems and methods. Regardless of the context of the specific details as they are discussed for any one of these embodiments, it is understood that such discussion relates to all other embodiments as well.

The present disclosure is drawn to a multi-chamber container for storing and mixing fluids. The container can include a first chamber configured to contain a first liquid composition as well as a second chamber configured to contain a second liquid composition. A barrier can be operable to separate the first chamber and the second chamber. The container can also include a compliant mechanism movable between a first position and a second position and a plunger movable with the compliant mechanism to alter or remove the barrier. In the first position, the barrier can be operable to maintain the first liquid composition and the second liquid composition separate from one another. In the second position, the plunger can be operable to alter or remove the barrier to facilitate contact of the first liquid composition and the second liquid composition.

In one aspect, the disclosure provides an insert module for a container for storing and mixing liquids. The insert module can include a chamber configured to contain a liquid composition. The chamber can have an opening to drain the liquid composition from the chamber. A barrier can be operable with the opening of the chamber. The insert module can also include a compliant mechanism movable between a first position and a second position and a plunger movable with the compliant mechanism to alter or remove the barrier from the opening. In the first position, the barrier can be operable to maintain the liquid composition in the chamber. In the second position, the plunger can be operable to alter or remove the barrier to facilitate passage of the liquid composition through the opening.

In another aspect, the disclosure provides a multi-chamber container for storing and mixing liquids. The container can include a first chamber configured to contain a first liquid composition and a second chamber configured to contain a second liquid composition. The second chamber can have an opening to dispense liquid from the second chamber. The first chamber can be at least partially disposed in the opening of the second chamber and configured to facilitate dispensing liquid from the second chamber.

In yet another aspect, the disclosure provides a method for facilitating storing and mixing liquids. The method includes obtaining a multi-chamber container including a first chamber configured to contain a first liquid composition, a second chamber configured to contain a second liquid composition, a barrier operable to separate the first chamber and the second chamber, a compliant mechanism movable between a first position and a second position, and a plunger movable with the compliant mechanism, wherein in the first position, the barrier is operable to maintain the first liquid composition and the second liquid composition separate from one another. The method further includes facilitating removal of the barrier by the plunger, wherein in the second position, the plunger is operable to alter or remove the barrier to cause contact of the first liquid composition and the second liquid composition.

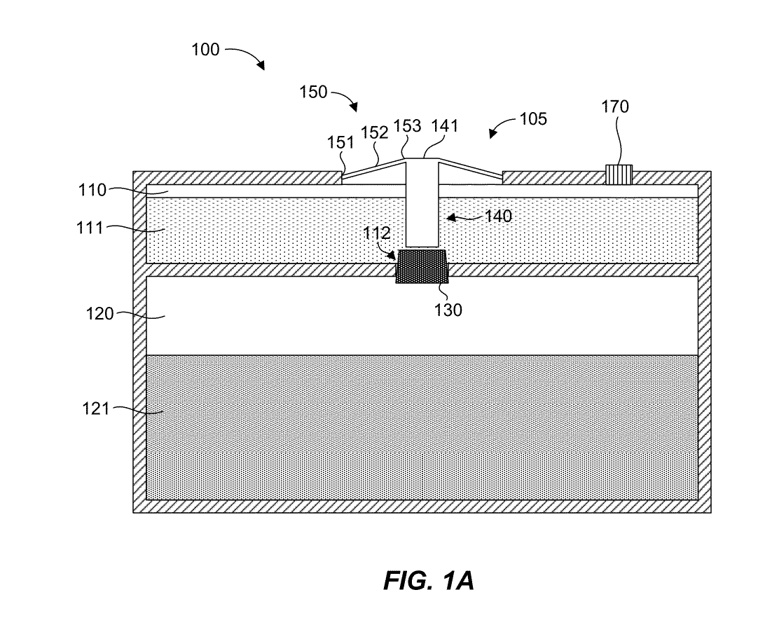

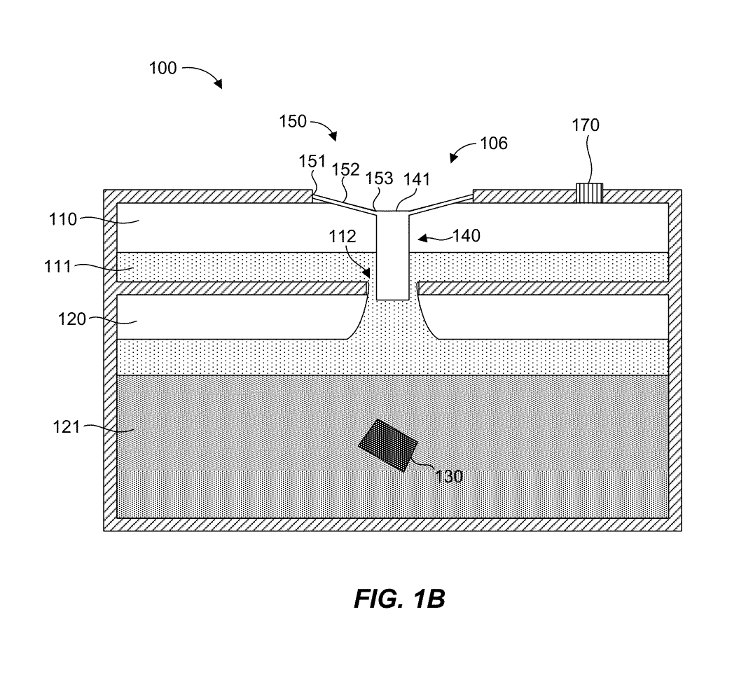

FIGS. 1A and 1B show a cross-sectional schematic view of one embodiment of a multi-chamber container 100 for storing and mixing liquids, in accordance with the present disclosure. The multi-chamber container can include a first chamber 110 configured to contain a first liquid composition 111 and a second chamber 120 configured to contain a second liquid composition 121. The multi-chamber container can further include a barrier 130, a compliant mechanism 150, and a plunger 140 to alter or remove the barrier. In one aspect, the second chamber can be smaller relative to the first chamber, although this need not be the case as the chambers can be of any size or configuration relative to one another. For example, the second chamber can be configured to contain a relatively small volume of a chemical concentrate, such as a peroxygen, and the first chamber can be configured to contain a relatively large volume of a diluent, such as water, alcohol, transition metal ions or colloids, etc., or vice versa. Other systems where one of the fluids is concentrated and at a smaller volume than the other fluid could likewise be configured to be in the second and first containers, respectively. That being stated, it is noted that the terms “first” and “second” are merely relative terms, and thus, the first chamber can be switched with the second chamber in various embodiments described herein.

The barrier 130 can separate the first liquid composition 111 and the second liquid composition 121. For example, an opening 112 can be configured to fluidly couple the first chamber and the second chamber and the barrier can cover or block the opening, preventing contact or mixing of the first and second liquid compositions. In one aspect, the barrier can comprise a stopper displaceable by the plunger. For example, the stopper can be configured to interface with the first chamber to plug the opening and maintain the first liquid composition and the second liquid composition separate from one another. Accordingly, the barrier or stopper can be removed to facilitate contact of the first liquid composition and the second liquid composition. The first chamber and/or the second chamber can be configured to facilitate mixing of the first liquid composition and the second liquid composition in one or both of the chambers. In one aspect, the first liquid composition can pour or drain from the first chamber and mix with the second liquid composition in the second chamber. Such draining from the first chamber can occur naturally under the influence of gravity alone following removal of the barrier when the first chamber is disposed above the second chamber.

In one aspect, the compliant mechanism 150 can be movable between a first position 105 (FIG. 1A) and a second position 106 (FIG. 1B). In a particular aspect, the compliant mechanism can be bi-stable in the first and second positions. The compliant mechanism can be associated with the first chamber 110 opposite the barrier 130. For example, the compliant mechanism can form a portion of the first chamber. Thus, the compliant mechanism can be configured to contain fluid within the first chamber. In one aspect, the compliant mechanism can include an outer hinge portion 151, a ligament 152, and an inner hinge portion 153. Movement of the ligament between the first and second positions can cause the inner and outer hinge portions to flex or bend to accommodate the movement. In one aspect, the inner and/or outer hinge portions can resiliently flex or bend to accommodate movement of the compliant mechanism to bi-stable first and second positions.

The plunger 140 can be movable with and/or by the compliant mechanism 150 to alter or remove the barrier 130. For example, in the first position 105 of the compliant mechanism, the barrier can be operable to maintain the first liquid composition 111 and the second liquid composition 121 separate from one another. In the second position 106 of the compliant mechanism, however, the plunger can be operable to alter or remove the barrier to facilitate contact of the first liquid composition and the second liquid composition. In one aspect, the barrier or stopper can be located inside the container 100 prior to removal of the barrier and can be accessible only by the plunger when blocking the opening 112. Once removed from the opening 112, the barrier or stopper can fall into the second chamber 120, thus being captured to remain with the container following removal from the opening.

In one aspect, the plunger 140 can be associated with the first chamber 110, such that the plunger is operable to alter or remove a barrier 130 associated with the first chamber. For example, as shown in FIGS. 1A and 1B, the plunger can be supported about the first chamber by the compliant mechanism 150, in this case at least initially, completely inside the first chamber. In one aspect, the compliant mechanism can also function to limit the travel or distance the plunger can extend into the first and/or second chambers. Additionally, the plunger and/or compliant mechanism can include a user interface 141, such as a push tab, to provide a user-friendly contact point with the plunger and/or compliant mechanism from outside the first chamber. Thus, the compliant mechanism can form a flexible yet liquid-tight portion of the first chamber to maintain the first liquid composition within the first chamber while facilitating operation of the plunger by a user to alter or remove the barrier from outside the first chamber. In other words, the compliant mechanism can transfer motion through a sealed chamber to the plunger to alter or remove the barrier, which seal can remain intact with regard to the compliant mechanism.

In addition, the multi-chamber container 100 can include a vent 170 operable with the first chamber 110 to facilitate venting of the first chamber. In one aspect, the vent can comprise a one-way valve to facilitate the escape of gas from the first chamber without allowing for the escape of liquid from the first chamber. In another aspect, the vent can be configured to facilitate draining of the first chamber when the barrier 130 is alter or removed. The vent can be of any suitable type or configuration, such as comprising a gas permeable barrier and/or a valve. Although only one vent is illustrated associated with the first chamber, it should be recognized that any number or type of vent may be used in any combination with any chamber of a multi-chamber container.

The multi-chamber containers, or components thereof, and associated methods of the present invention can be used with any multi-part liquid composition or system. The containers are particularly advantageous for multi-part compositions which have limited or shortened stabilities, shelf-lives, or functional time periods once combined. As such, in one aspect of the present disclosure, removing a barrier to facilitate contact of the first liquid composition and the second liquid composition can be performed shortly before dispensing the mixed liquids from the second chamber, such as from an opening (not shown). An example of a multi-part system which can be used herein is a multi-part disinfectant composition which, in its final form, can include a composition with an amount of a transition metal, e.g. a colloidal or ionic transition metal, and a peroxygen, e.g., peracids and/or peroxides. The composition could also include other ingredients such as alcohols or other organic co-solvents, or even dispersed particles, such as colloidal metals. Thus, the peroxygen can be separated from the transition metal until mixing, and in one embodiment, or any other two ingredients can remain separate until the mixture is formed, as would be appreciated by one skilled in the art. It is emphasized, however, that this system is not limited to this particular two part system. Any system where there are two fluids that should remain separate until activation or combination can benefit from the containers of the present disclosure. For example, a system that includes a concentrate in one of the chambers and a diluent (e.g., water, water/alcohol, etc.) in the other container would also benefit from this system. Thus, the “add water” step would occur simply by pushing the plunger. This would be useful if the concentrate was more stable than when diluted. Likewise, many other two part systems could be separated using the containers of the present disclosure.

That being stated, if the two part system is a disinfectant system, in one specific example, the above described disinfectant system can be effectively used to provide disinfection of a wide variety of surfaces. However, when a peracid is used, the peracid component of the composition can have a limited shelf-life, particularly at concentrations that are relatively low. As such, the present disclosure provides an effective means for safely packaging, handling, shipping, storing, and ultimately mixing such a composition in a two-component format (at an initial higher concentration) until shortly before use. For example, the above described disinfectant composition could be packaged into a multi-chamber container of the present disclosure such that an aqueous vehicle, including a transition metal (ionic or colloidal) component and/or alcohol or possibly other organic components are placed in the larger second chamber of the container, while a concentrated, and thereby more stable, peracid liquid is placed in the smaller first chamber. By maintaining a somewhat elevated concentration of peracid in the liquid of the first chamber, the peracid has an enhanced stability, and therefore a longer shelf-life. Further, the present disclosure provides for a safe means for packaging such individually separated compositions. Typically, solutions having elevated peracid concentrations are viewed as being hazardous, and therefore, difficult to ship and sell to the public. The multi-chamber containers of the present disclosure would allow for the peracid liquid to be packaged within the first chamber and enclosed within the container for safety. Such a configuration makes the system more safely shipped and stored because any leak from the first chamber would be retained within the container and, if the barrier separating the chambers is removed, safely dispersed and neutralized into the second liquid present in the second chamber. Specific details of one specific type of composition which can be used in the systems of the present inventions are described in U.S. Pat. No. 7,473,675, which is incorporated herein by reference. In one aspect, compositions that can be used include a bleach concentrate with water, paint components, or any other suitable composition applicable to two part chemistries or mixtures.

The configuration of the barrier 130, the compliant mechanism 150, and the plunger 140 can be particularly advantageous when the liquid present in the first chamber 110 is a dangerous or hazardous liquid. For example, if the liquid in the first chamber is a concentrated acid, the user does not need to be exposed to the concentrated acid in order to facilitate the mixing of the acid with the liquid in the second chamber 120. The fluid within the first chamber is only exposed to an external environment when the barrier separating the first and second chambers is removed inside the multi-chamber container 100.

It should be recognized that any number of chambers and liquid compositions can be included in a multi-chamber container in accordance with the present disclosure. Moreover, it should be recognized that the plunger configurations and associated chambers can be combined in any arrangement or embodiment disclosed herein.

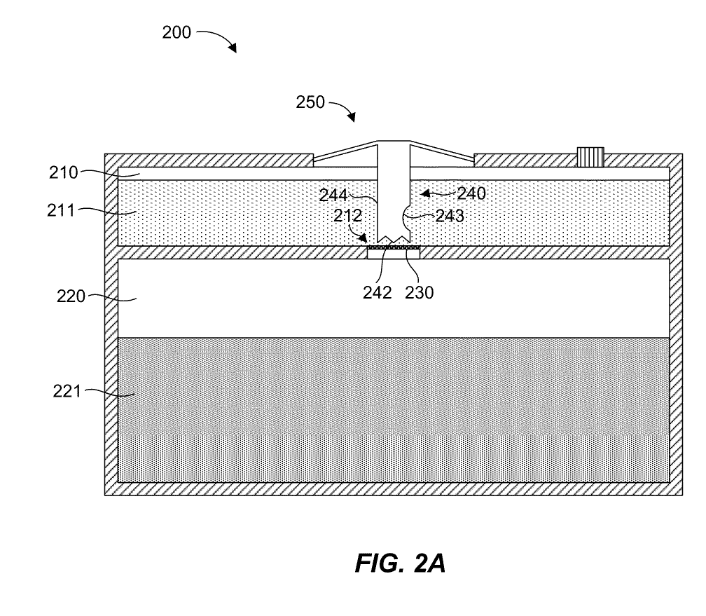

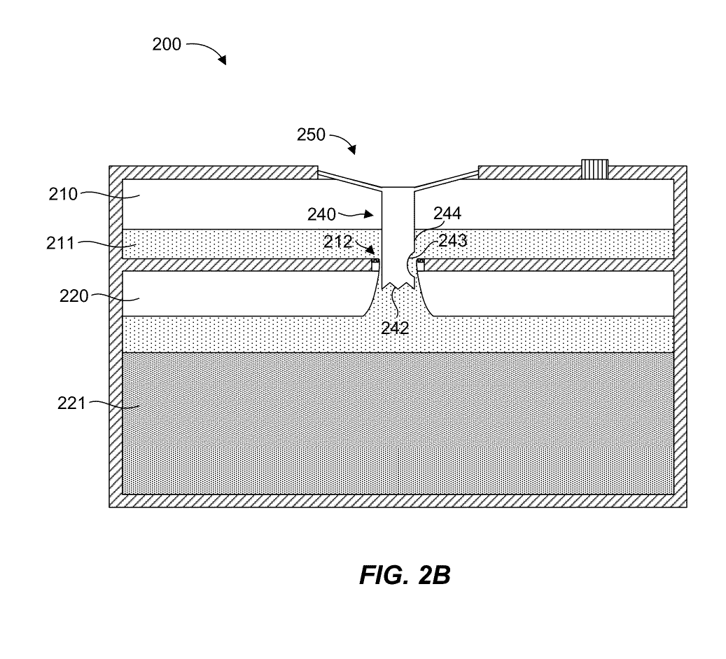

FIGS. 2A and 2B show a cross-sectional schematic view of another embodiment of a multi-chamber container 200 for storing and mixing liquids, in accordance with the present disclosure. Similar to other embodiments described herein, the multi-chamber container 200 can include a first chamber 210 configured to contain a first liquid composition 211, a second chamber 220 configured to contain a second liquid composition 221, a barrier 230 separating the first liquid composition and the second liquid composition, a compliant mechanism 250, and a plunger 240 movable with the compliant mechanism to alter or remove the barrier. In this case, the barrier 230 can comprise a puncturable membrane. In one aspect, the membrane can cover an opening 212 configured to drain the first liquid composition from the first chamber. Thus, the plunger can include a piercing feature 242, such as one or more sharp points or protrusions, to facilitate puncturing of the membrane. In one aspect, the piercing feature can comprise a single or a plurality of pointed or sharp protrusions or it can take any other shape or size so long as it is effective in ripping, tearing, penetrating, puncturing, rupturing, or otherwise breaking the membrane. The plunger can also include a recess 243 or even a channel (not shown) to facilitate passage of fluid around a shaft 244 the plunger when the plunger shaft is extending through the punctured membrane, as shown in FIG. 2B. The compliant mechanism in a bi-stable configuration can tend to prevent retraction of the plunger upon puncturing the membrane 230. Even if the plunger where to be retracted, however, the compliant mechanism can be configured to prevent fluid from escaping the first chamber 210.

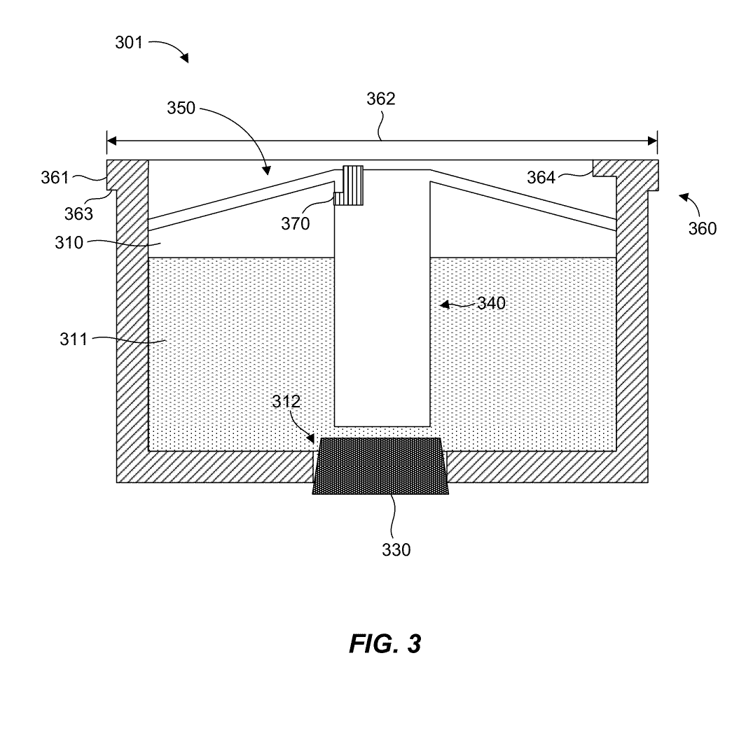

With reference to FIG. 3, shown is a cross-sectional schematic view of one embodiment of an insert module 301 for a container for storing and mixing liquids, in accordance with the present disclosure. Similar to the concepts and features disclosed above with reference to FIGS. 1A and 1B, the insert module can include a chamber 310 configured to contain a liquid composition 311. The chamber can have an opening 312 configured to drain the liquid composition from the chamber. The insert module can also include a barrier 330 operable with the opening of the chamber to block the opening. In the example shown, the barrier is a removable or displaceable stopper that can be displaced to allow mixing of the liquids, but it is understood that in this or any other example, the barrier can be any removable or ruptureable structure, such as a ruptureable membrane, or pop-out portion that may be injection molded therein, or the like. The displaceable stopper can be configured to stay intact until pushed out by a plunger 340, leaving the opening for mixing of the fluids. With respect to the membrane, this can be ruptureable as describe in the previous FIGS, for example. Regarding the pop-out portion (not shown, but can be used as an alternative to the displaceable stopper), this portion can include a central section that interfaces with the lowermost portion of the plunger and also include a weakened area circumscribing the pop-out portion that is pushed on by the plunger. In this manner, the pop-out portion can give way, allowing the fluids to mix. Other possible mechanisms can likewise be used.

Thus, the insert module can include a compliant mechanism 350 and a plunger 340, which can be movable with the compliant mechanism to alter or remove the barrier from the opening. The compliant mechanism can be pushed and remain in a downward configuration, or can rebound back in place, depending on the application. Other mechanisms for pushing the plunger can also be used, including plungers without the compliant mechanism that use seals to prevent leakage where the plunger enters the container, or plungers that are pushed downward and held in place using threads from the cap or other threaded structure. In addition, a vent 370 can be operable with the chamber 310 to facilitate venting of the chamber. In this case, the vent can be associated with the compliant mechanism and/or the plunger.

The insert module 301 can also have an interface portion 360 for interfacing the insert module with a container, such as an opening or a pour spout of a container. The interface portion can comprise any mechanism known in the art for interfacing and/or coupling with an opening or pour spout of a container, including but not limited to threads, clamps, interference fittings, adhesives, bonding, welding, detents, etc. The insert module can therefore be screwed or threaded into the container, or pushed or pressed into the container. Other connection mechanisms can also be used to operably connect the insert module and the container. For example, in one embodiment, the interface portion of the insert module can include one or more features 361 having an outer diameter 362 configured to fit with an inner diameter of a container opening, such as a press or interference fit, thereby operably connecting the insert module and the container. Other methods of operably connecting the insert module and the container can also be used. In one aspect, the interface portion can comprise a lip 363 configured to interface with a rim of the container about an opening or pour spout. In another aspect, the insert module can include a tab 364 or other feature to aid in removal of the insert from a container. For example, in the embodiment illustrated in FIG. 3, the insert module can occupy or block an entire opening or pour spout of a container. Thus, after mixing liquid compositions, the insert module can be removed from the container to facilitate dispensing liquid from the container. The tab can therefore facilitate removal of the insert module from the container prior to dispensing fluid from the container.

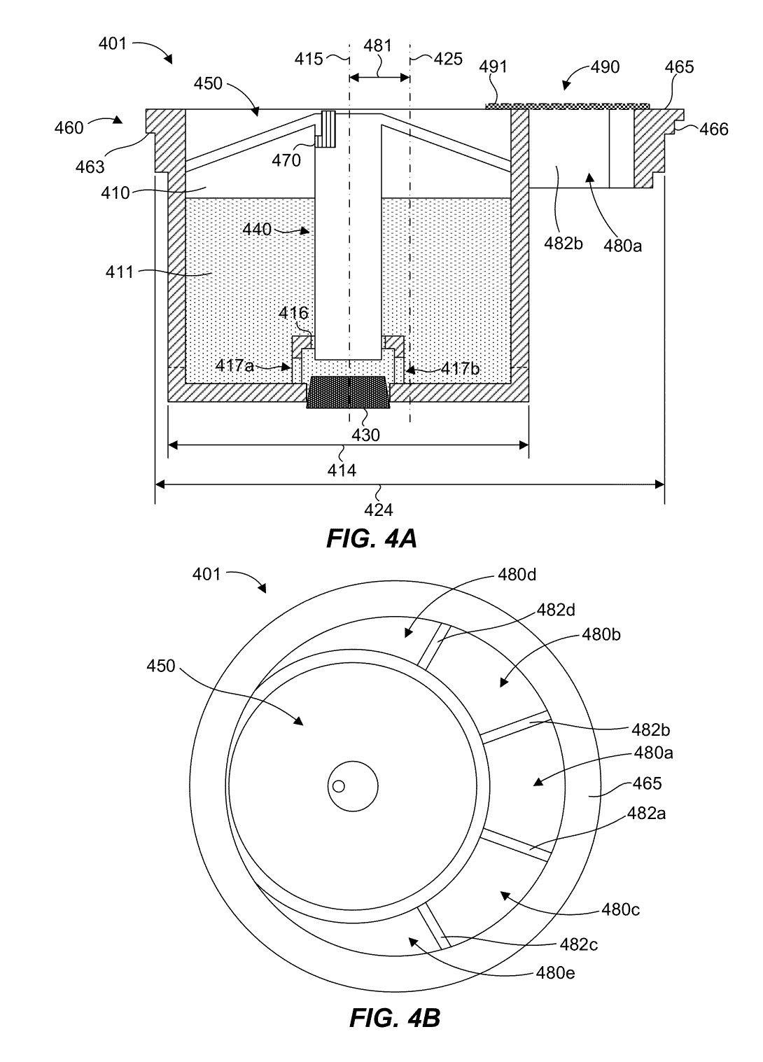

FIGS. 4A and 4B show cross-sectional and top schematic views, respectively, of another embodiment of an insert module 401 for a container for storing and mixing liquids, in accordance with the present disclosure. Similar to the insert module 301 illustrated in FIG. 3, the insert module 401 can include a chamber 410 having an opening to drain a liquid composition 411 from the chamber, a barrier 430 operable with the opening of the chamber, a compliant mechanism 450, and a plunger 440 movable with the compliant mechanism to alter or remove the barrier from the opening. In addition, a vent 470 can be associated with the compliant mechanism and/or the plunger to facilitate venting of the chamber.

In this embodiment, however, the insert module 401 can be configured to occupy only a portion of an opening or pour spout of a container, such that the insert module can remain in place while fluid is dispensed from the container. In other words, the insert module chamber 410 can be configured to be at least partially disposed in an opening or pour spout of the container to facilitate dispensing liquid from the container. For example, a diameter 414 of the insert module chamber can be less than a diameter 424 of the opening of the container chamber (not shown). This can result in a fluid passageway 480a-e between the chamber structure and the outer rim 465 of the insert module for dispensing liquid from the container with the insert module in the container opening or pour spout. As shown in FIGS. 4A and 4B, a center 415 of the chamber is configured to be offset 481 to a side from a center 425 of an opening or pour spout of a container, which can define the fluid passageway on an opposite side. In this case, the insert module can also include an alignment key 466 to interface with a keyway in the container to correctly align the fluid passageway relative to the container for dispensing fluid. In this embodiment, the interface portion can be configured for a sliding or press fit to facilitate engagement of the key and the keyway. It should be recognized that the insert module chamber can be located in any suitable position relative to the outer rim and need not be offset as shown in the figures.

In addition, the insert module 401 can include one or more struts 482a-d or other supports extending between the chamber 410 structure and the outer rim 465 of the insert module. In one aspect, the struts can be configured to provide structural support for the chamber when a user applies a force to the plunger 440 to alter or remove the barrier 430. In another aspect, the struts can serve to block or prevent a displaced barrier or stopper from escaping the container when fluid is being dispensed from the container and/or block or prevent debris from entering the container.

The insert module 401 can also include a seal 490 (omitted from FIG. 4B for clarity), such as a foil seal or film, disposed over the fluid passageway 480a-e to prevent leaks or spills of fluid from the container prior to dispensing. The seal can remain intact, for example, during mixing of two fluid compositions, as described herein, and removed following mixing to facilitate dispensing of the mixture. The seal can be punctured or removed, such as with a pull tab 491, to facilitate dispensing or pouring the mixture from the container. For example, the container can be inverted to drain or pour the mixture from the container via the fluid passageway.

In one aspect, the insert module 401 can include a guide 416 to direct the plunger 440 into contact with the barrier 430, for example, as the plunger moves with the compliant mechanism 450. The guide can be associated with the chamber 410 and can include a ring, tab, rod, channel, or any other suitable feature or device to align the plunger with the barrier or otherwise direct the plunger into contact with the barrier. The guide can therefore ensure that the plunger is operable to displace the barrier when moved with the compliant mechanism. In addition, one or more openings 417a, 417b can be included at a base of the guide to facilitate draining of the fluid composition 411 from the chamber upon removal of the barrier.

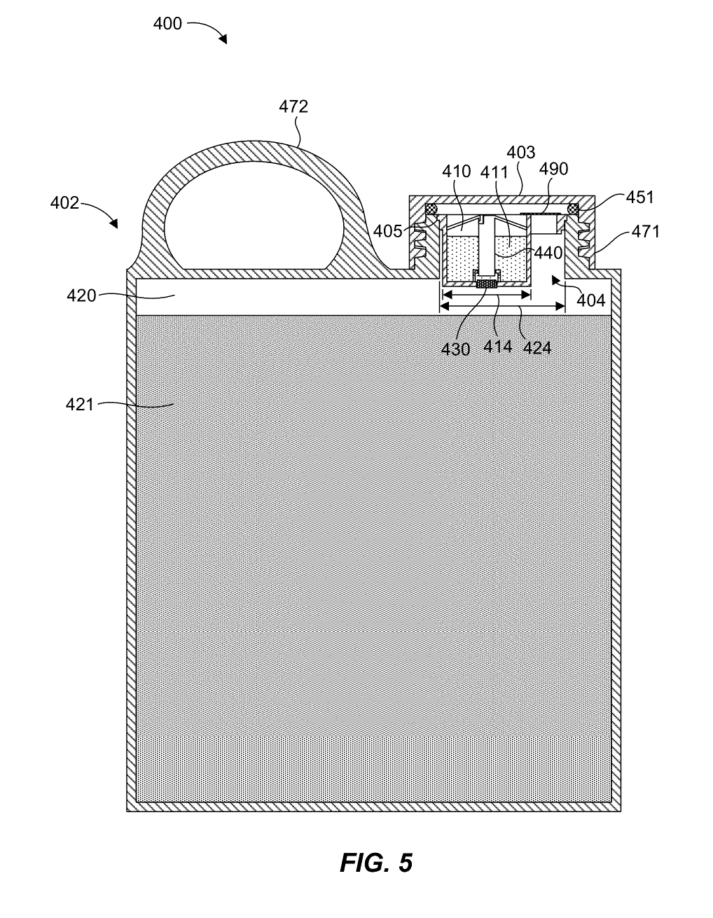

With continued reference to FIGS. 4A and 4B, the insert module 401 can also include an interface portion 460 for interfacing the insert module with a container 402, such as with an opening 404 or a pour spout of the container, as illustrated in FIG. 5. The interface portion can be formed in the outer rim 465 of the insert module. In one aspect, the interface portion can comprise a lip 463 configured to interface with a rim 405 of the container about the pour spout. The container can include a chamber 420 configured to contain a liquid composition 421. The opening or pour spout can be configured to dispense liquid from the chamber. In one aspect, the insert module can be at least partially disposed in the opening or pour spout and configured to facilitate dispensing liquid from the container chamber. For example, the chamber 410 of the insert module 401 can have a smaller diameter 414 relative to the diameter 424 of the opening or pour spout, such that the insert module chamber can be disposed, at least partially, within the container chamber. Thus, together, the insert module 401 and the container 402 can form a multi-chamber container 400 for storing and mixing liquids. In one aspect, the insert module can have a press or interference fit with the container to prevent the insert module from falling out when dispensing or pouring liquid from the container.

The multi-chamber container 400 can also include a cap 403. The cap can be coupled to the container 402 by any mechanism known in the art for coupling a cap to a container, including but not limited to threads, clamps, interference fittings, detents, etc. The cap can therefore be screwed or threaded onto the container, or pushed or pressed onto the container. Other connection mechanisms can also be used to operably connect the cap and the container. For example, in one embodiment, the opening of the container can have a plurality of external tabs which, when paired with corresponding slots in the cap, form a locking mechanism, thereby operably connecting the cap and the container. Other methods of operably connecting the cap and the container can also be used. The cap can also include a seal 451, such as an O-ring, to prevent or minimize leakage of fluid out of the container through the interface of the cap and the container, such as around or through coupling features.

In one aspect, the insert module can be configured to interface with a standard or unmodified container and cap. In this case, the lip 463 of the insert module can be configured to interface with a top surface of the rim 405 about the opening or pour spout of the container, which in some embodiments may cause the seal 451 to interface with the insert module and the cap. In another aspect, the container can be specifically adapted to interface with the insert module. For example, the rim of the container can be recessed, as shown in FIG. 5, to interface with the lip of the insert module, which can facilitate an interface of the seal with the container and the cap thus providing the usual sealing mechanism for such a container.

The cap 403 can prevent accidental removal of the barrier 430 when secured to the container and can be removed to facilitate access for operation of the plunger 440 and/or dispensing of liquid from the container. In one aspect, the cap and/or the insert module 401 can be configured to provide a gap 406 to prevent the cap from contacting the plunger, which could cause the plunger to remove the barrier accidentally and/or prematurely.

When the insert module 401 is operably coupled to the container 402 to form the multi-chamber container 400, the configuration can facilitate contacting of the liquids contained in the respective chambers. For example, the plunger 440 can alter or remove the barrier 430 to facilitate draining of the fluid 411 from the chamber 410 into the fluid 421 in the chamber 420. In one example, the larger chamber could be considered the “first” chamber, and the smaller chamber could be considered the “second” chamber, or vice versa, depending on the embodiment. After mixing the fluids, the insert module can facilitate dispensing of the composition in any suitable manner, such as by pouring, spraying, etc. via the opening or pour spout of the container. The container 402 can include a handle 472 to enable the user to more easily manipulate the container.

In use, the cap 403 can be removed from the container 402 to expose the insert module 401. The plunger 440 can then be caused to alter or remove the barrier 430, thus facilitating draining or emptying of the fluid 411 from the insert module chamber 410 into the container chamber 420 where the fluid 411 can mix with the fluid 421. For example, the multi-chamber container 400 can then be shaken to mix the fluids 411, 421. The seal 490 can then be removed to dispense the mixed fluid from the multi-chambered container, such as by pouring the fluid from the opening 404 or pour spout of the container. One benefit of the multi-chambered container is reduced or minimized hand motion and/or steps to dispense the mixed fluid.

The configuration of the barrier 430, the compliant mechanism 450, and the plunger 440 can be particularly advantageous when the liquid present in the first chamber 410 is a dangerous or hazardous liquid. For example, if the liquid in the insert module chamber is a concentrated acid, the user does not need to be exposed to the concentrated acid in order to facilitate the mixing of the acid with the liquid in the container chamber 420. The fluid within the insert module chamber is only exposed to an external environment when the barrier separating the chambers is removed inside the multi-chamber container 400.

In one aspect, the multi-chamber container 400 can be refillable and reusable. For example, when the liquid in the container has been consumed, the container chamber can be refilled and the insert module, which includes the chamber 410 and the plunger 440, can be removed from the container 402, disposed of, and replaced with a new insert module.

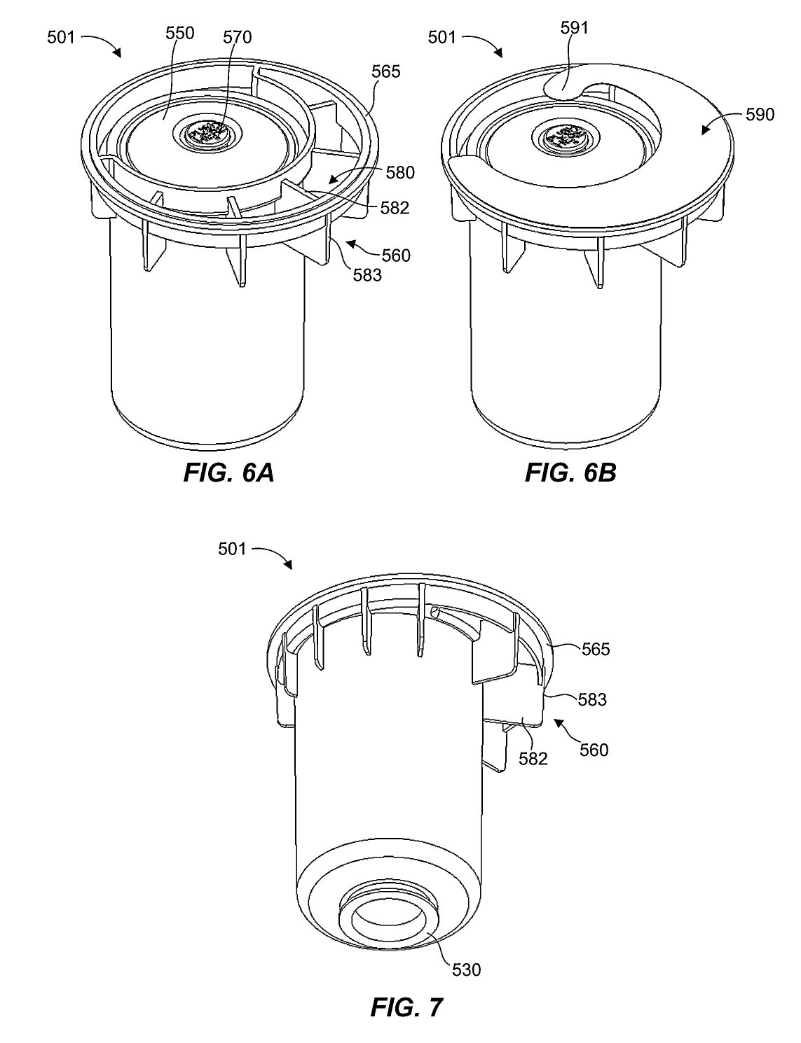

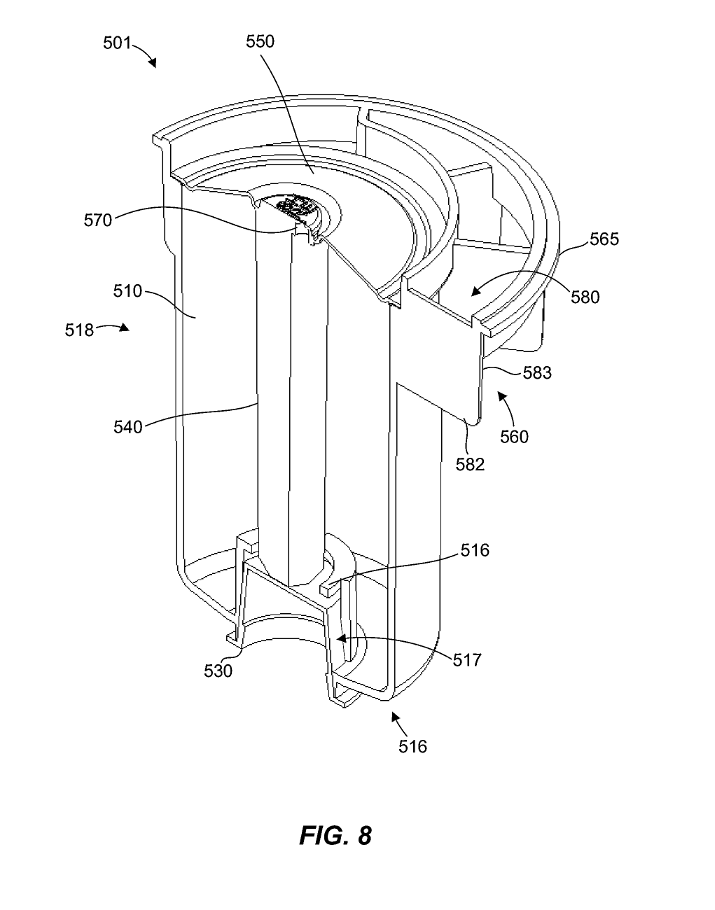

FIGS. 6A-8 illustrate another embodiment of an insert module 501 for a container for storing and mixing liquids, in accordance with the present disclosure. Similar to other insert module embodiments described herein, the insert module 501 can include a chamber 510 having an opening to drain a liquid composition from the chamber, a barrier 530 operable with the opening of the chamber, a compliant mechanism 550, and a plunger 540 movable with the compliant mechanism to alter or remove the barrier from the opening. In addition, a vent 570 can be associated with the compliant mechanism and/or the plunger to facilitate venting of the chamber.

The insert module 501 can also be configured to occupy only a portion of an opening or pour spout of a container, such that the insert module can remain in place while fluid is dispensed from the container. In other words, the insert module chamber can be configured to be at least partially disposed in an opening or pour spout of the container to facilitate dispensing liquid from the container, such as via a fluid passageway 480. Accordingly, the insert module can include one or more struts 582 or other supports, as disclosed hereinabove, extending between the chamber 510 and an outer rim 565 of the insert module. In one aspect, the struts can be configured to form part of an interface portion 560 with a container, such as a pour spout. For example, ends 583 of the struts can be configured to be pushed or pressed into the container, such as to provide an interference fit with an inner diameter of a pour spout of the container.

As with other embodiments, the insert module 501 can also include a seal 590 (FIG. 6B) disposed over the fluid passageway 480 to prevent leaks or spills of fluid from the container prior to dispensing. The seal can remain intact, for example, during mixing of two fluid compositions, as described herein, and removed following mixing to facilitate dispensing of the mixture. The seal can be punctured (altered) or removed, such as with a pull tab 591, to facilitate dispensing or pouring the mixture from the container. Also, the insert module can include a guide 516 to direct the plunger into contact with the barrier 530, for example, as the plunger moves with the compliant mechanism 550. The guide can be associated with the insert module chamber and can include a ring, tab, rod, channel, or any other suitable feature or device to align the plunger with the barrier or otherwise direct the plunger into contact with the barrier. The guide can therefore ensure that the plunger is operable to displace the barrier when moved with the compliant mechanism. In addition, one or more openings 517 can be included at a base of the guide to facilitate draining of the fluid composition from the chamber upon removal of the barrier.

The various components and elements of the insert module 501 can be formed of a single unitary structure or as one or more individual components assembled and coupled together. For example, a lower portion 516 of the chamber 510 can be formed separately from an upper portion 518 of the chamber and can be welded, glued, heat sealed, bonded, adhered, or otherwise coupled together to form the chamber. Likewise, the compliant mechanism 550 can be formed separate of the plunger 540 and/or the chamber and similarly attached.

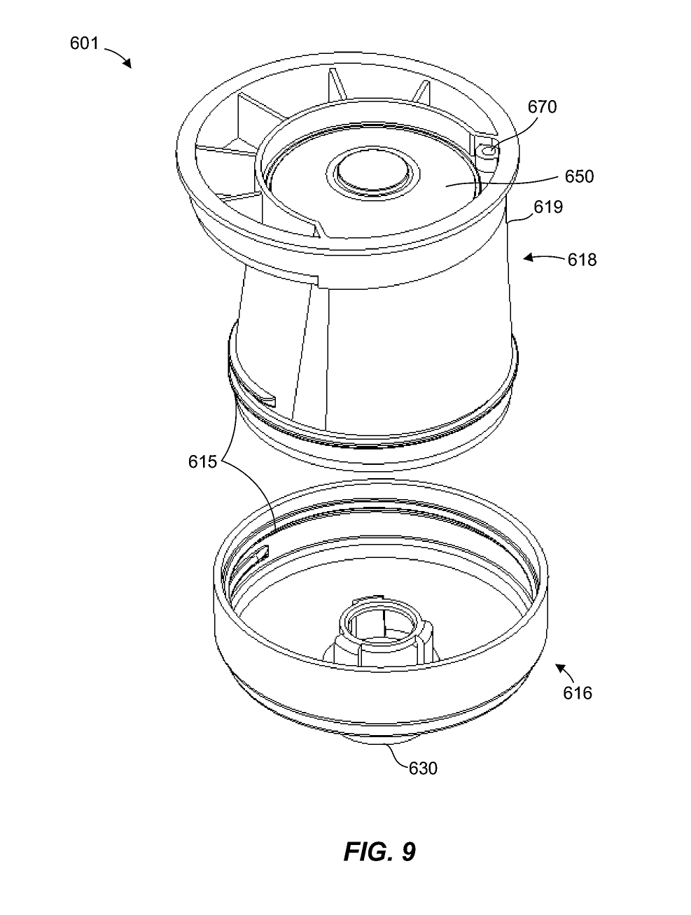

FIGS. 9 and 10 illustrate yet another embodiment of an insert module 601 for a container for storing and mixing liquids, in accordance with the present disclosure. The insert module 601 is similar to the insert module 501 discussed above with reference to FIGS. 6A-8 in many respects. For example, the insert module 601 can include a chamber 610 having an opening to drain a liquid composition from the chamber, a barrier 630 operable with the opening of the chamber, a compliant mechanism 650, and a plunger 640 movable with the compliant mechanism to alter or remove the barrier from the opening. In addition, a vent 670 can be associated with the compliant mechanism and/or the plunger to facilitate venting of the chamber. The insert module 601 can also be configured to occupy only a portion of an opening or pour spout of a container, such that the insert module can remain in place while fluid is dispensed from the container. In this case, a lower portion 616 of the chamber can be formed separately from an upper portion 618 of the chamber and can be coupled together via a threaded interface 615 to form the chamber. Also, in this embodiment, the vent is separate from the compliant mechanism and is disposed proximate to a wall 619 of the chamber adjacent to the compliant mechanism.

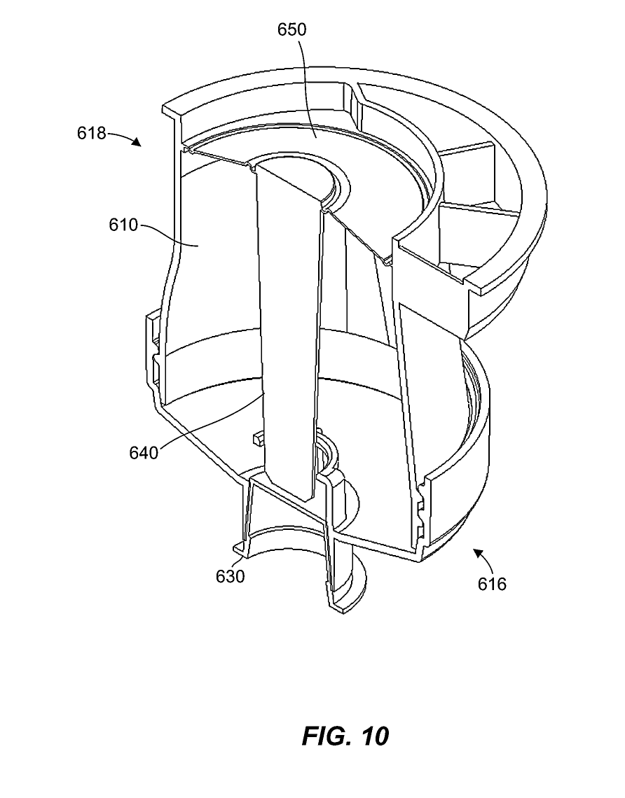

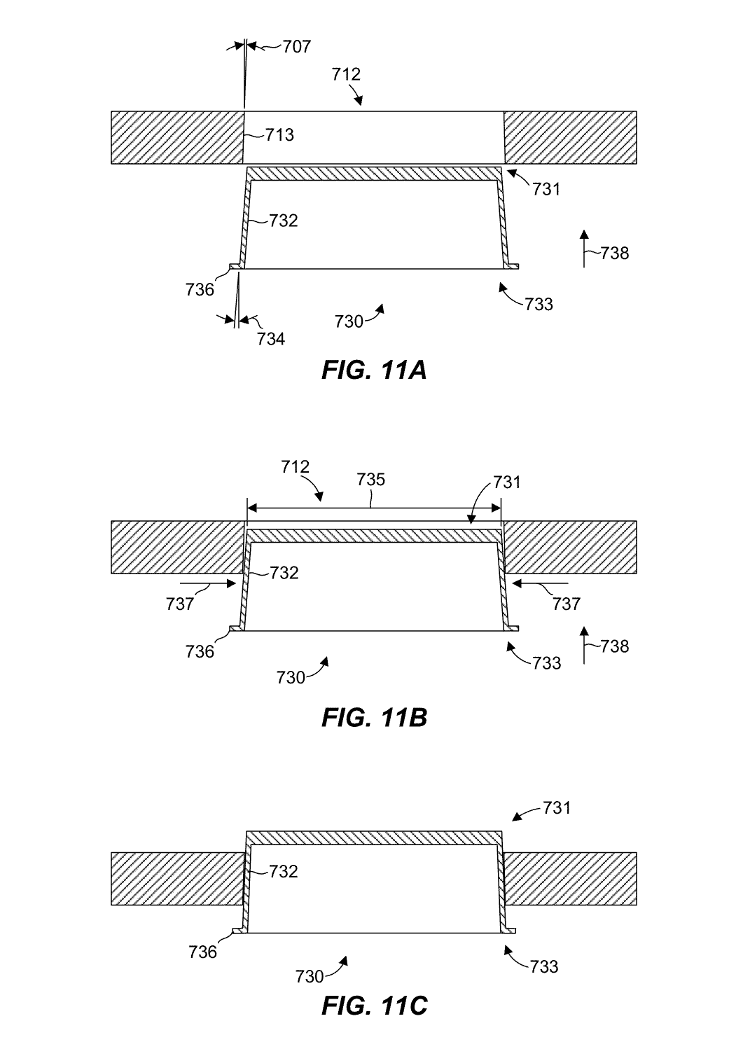

FIGS. 11A-11C show a schematic illustration of a stopper barrier 730 of a multi-chamber container for storing and mixing liquids, in accordance with the present disclosure. In one aspect, the stopper can be configured to be inverted and inserted in direction 738 into an opening 712 or receptacle at a bottom of a chamber configured to contain a liquid. For example, once a chamber has received a liquid the stopper can be disposed in the opening to prevent the liquid from escaping through the bottom of the chamber until displaced by a plunger. When desired, the stopper can be displaced by a plunger to open up a relatively large flow hole or exit location for the liquid through the opening. Thus, the inverted stopper can be located inside a multi-chamber container where a user cannot access the stopper for removal except via a plunger and a compliant mechanism, as described hereinabove.

The stopper 730 can have a closed end 731, a side wall 732, and an open end 733. The side wall can be configured at an angle 734. The opening 712 can be defined, at least in part, by a side wall 713, which can be configured at an angle 707. In one aspect, the closed end of the stopper can be relatively rigid and inflexible and therefore less conducive to radial compression upon contact with the side wall of the opening upon insertion. Thus, as shown in FIG. 11B, a diameter 735 of the closed end 731 can be configured to fit within the opening such that the side wall 713 of the opening does not contact the closed end in a manner that would tend to radially compress the closed end, which facilitates ease of insertion of the stopper into the opening. On the other hand, the side wall 732 of the stopper can be relatively easy to radially deflect 737 by the side wall of the opening upon insertion. Thus, the side wall 732 of the stopper can be configured to contact the side wall 713 of the opening in a manner that would tend to radially compress the side wall 732 upon insertion into the opening. A rim 736 about the open end of the stopper can be configured to provide some additional radial stiffness for the open end as the side wall 732 deflects or compresses upon insertion. The rim can therefore maintain structural integrity of the open end as the side wall radially compresses inward upon insertion.

One benefit of this configuration is that the stopper 730 can be relatively insensitive to pressure from the side. Thus, pressure from inside the chamber may not push the side wall 732 of the stopper inward, which would tend to lessen the ability of the stopper to remain in place. In one aspect, therefore, the stopper can be removed only by a force acting on the closed end, such as from a plunger, which can easily displace the stopper. This attribute can enable the stopper to remain in place even when the chamber is dropped.

In accordance with one embodiment of the present invention, a method for facilitating storing and mixing liquids is disclosed. The method can comprise obtaining a multi-chamber container including a first chamber configured to contain a first liquid composition, a second chamber configured to contain a second liquid composition, a barrier operable to separate the first chamber and the second chamber, a compliant mechanism movable between a first position and a second position, and a plunger movable with the compliant mechanism, wherein in the first position, the barrier is operable to maintain the first liquid composition and the second liquid composition separate from one another. Additionally, the method can comprise facilitating removal of the barrier by the plunger, wherein in the second position, the plunger is operable to alter or remove the barrier to cause contact of the first liquid composition and the second liquid composition. In one aspect, the multi-chamber container can comprise an insert module comprising the first chamber, the barrier, the compliant mechanism, and the plunger. It is noted that no specific order is required in this method, though generally in one embodiment, these method steps can be carried out sequentially.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A multi-chamber container for storing and mixing liquids, comprising:
a first chamber configured to contain a first liquid composition;
a second chamber configured to contain a second liquid composition;
a barrier operable to separate the first chamber and the second chamber;
a compliant mechanism movable between a first position and a second position; and
a plunger movable with the compliant mechanism to alter or remove the barrier,
wherein in the first position, the barrier is operable to maintain the first liquid composition and the second liquid composition separate from one another, and in the second position, the plunger is operable to alter or remove the barrier to facilitate contact of the first liquid composition and the second liquid composition.

2. The multi-chamber container of claim 1, wherein the barrier comprises a stopper displaceable by the plunger.

3. The multi-chamber container of claim 2, wherein the stopper is configured to interface with the first chamber to plug an opening of the first chamber and maintain the first liquid composition and the second liquid composition separate from one another.

4. The multi-chamber container of claim 2, wherein the stopper comprises a side wall configured to compress upon insertion into the opening.

5. The multi-chamber container of claim 1, wherein the barrier comprises a membrane puncturable by the plunger.

6. The multi-chamber container of claim 5, wherein the membrane covers an opening configured to drain the first liquid composition from the first chamber.

7. The multi-chamber container of claim 1, wherein the compliant mechanism is associated with the first chamber opposite the barrier.

8. The multi-chamber container of claim 7, wherein the compliant mechanism forms a portion of the first chamber.

9. The multi-chamber container of claim 1, further comprising a guide to direct the plunger into contact with the barrier as the compliant mechanism moves to the second position.

10. The multi-chamber container of claim 1, further comprising a pour spout to dispense liquid from the second chamber, wherein the first chamber is at least partially disposed in the pour spout and configured to facilitate dispensing liquid from the second chamber.

11. The multi-chamber container of claim 1, wherein the first chamber and the second chamber are configured to facilitate mixing of the first liquid composition and the second liquid composition in at least one of the first chamber and the second chamber.

12. The multi-chamber container of claim 11, wherein the first chamber is disposed above the second chamber.

13. The multi-chamber container of claim 11, further comprising an insert module for the container, wherein the insert module comprises the first chamber, the barrier, the compliant mechanism, and the plunger.

14. The multi-chamber container of claim 1, wherein the plunger is associated with the first chamber.

15. The multi-chamber container of claim 1, further comprising a vent operable with the first chamber to facilitate venting of the first chamber.

16. The multi-chamber container of claim 15, wherein the vent comprises a one-way vent to facilitate venting of a gas from the first chamber.

17. The multi-chamber container of claim 1, wherein the first chamber contains the first liquid composition.

18. The multi-chamber container of claim 17, wherein the second chamber contains the second liquid composition.

19. The multi-chamber container of claim 1, wherein the first liquid composition includes a peroxygen and the second liquid composition includes a transition metal.

20. The multi-chamber container of claim 19, wherein the transition metal includes colloidal silver.

21. The multi-chamber container of claim 19, wherein the peroxygen includes a peroxide.

22. The multi-chamber container of claim 19, wherein the peroxygen includes a peracid.

23. An insert module for a container for storing and mixing liquids, comprising:
a chamber configured to contain a liquid composition, the chamber having an opening to drain the liquid composition from the chamber;
a barrier operable with the opening of the chamber;
a compliant mechanism movable between a first position and a second position; and
a plunger movable with the compliant mechanism to alter or remove the barrier from the opening,
wherein in the first position, the barrier is operable to maintain the liquid composition in the chamber, and in the second position, the plunger is operable to alter or remove the barrier to facilitate passage of the liquid composition through the opening.

24. The insert module of claim 23, wherein the container comprises a pour spout to dispense liquid from the container, and wherein the chamber is configured to be at least partially disposed in the pour spout to facilitate dispensing liquid from the container.

25. The insert module of claim 24, further comprising an interface portion for interfacing the insert module with the container.

26. The insert module of claim 25, wherein the interface portion comprises a lip configured to interface with a rim of the container about the pour spout.

27. The insert module of claim 23, further comprising a vent operable with the chamber to facilitate venting of the chamber.

28. A multi-chamber container for storing and mixing liquids, comprising:
a first chamber configured to contain a first liquid composition;
a second chamber configured to contain a second liquid composition, and having an opening to dispense liquid from the second chamber,
wherein the first chamber is at least partially disposed in the opening of the second chamber and configured to facilitate dispensing liquid from the second chamber.

29. The multi-chamber container of claim 28, wherein a first diameter of the first chamber is less than a second diameter of the opening of the second chamber.

30. The multi-chamber container of claim 28, wherein the opening of the second chamber comprises a pour spout, and a wall of the first chamber provides a wall for the pour spout.

31. The multi-chamber container of claim 28, further comprising an insert module for the container, wherein the insert module comprises the first chamber.

32. The multi-chamber container of claim 28, wherein the first chamber is operable to dispense the first liquid composition into the second liquid composition.

33. The multi-chamber container of claim 28, further comprising:
a barrier operable to separate the first chamber and the second chamber;
a compliant mechanism movable between a first position and a second position; and
a plunger movable with the compliant mechanism to alter or remove the barrier,
wherein in the first position, the barrier is operable to maintain the first liquid composition and the second liquid composition separate from one another, and in the second position, the plunger is operable to alter or remove the barrier to facilitate contact of the first liquid composition and the second liquid composition.

34. A method for facilitating storing and mixing liquids, comprising:
obtaining a multi-chamber container including a first chamber configured to contain a first liquid composition, a second chamber configured to contain a second liquid composition, a barrier operable to separate the first chamber and the second chamber, a compliant mechanism movable between a first position and a second position, and a plunger movable with the compliant mechanism, wherein in the first position, the barrier is operable to maintain the first liquid composition and the second liquid composition separate from one another; and
facilitating removal of the barrier by the plunger, wherein in the second position, the plunger is operable to alter or remove the barrier to cause contact of the first liquid composition and the second liquid composition.

35. The method of claim 34, wherein the barrier comprises a stopper displaceable by the plunger.

36. The method of claim 34, wherein the barrier comprises a membrane puncturable by the plunger.

37. The method of claim 34, wherein the compliant mechanism forms a portion of the first chamber.

38. The method of claim 34, wherein the multi-chamber container further comprises a pour spout to dispense liquid from the second chamber, and the first chamber is at least partially disposed in the pour spout and configured to facilitate dispensing liquid from the second chamber.

39. The method of claim 34, wherein the multi-chamber container comprises an insert module comprising the first chamber, the barrier, the compliant mechanism, and the plunger.

40. The method of claim 34, wherein the first liquid composition includes an alcohol.

41. The method of claim 34, wherein the first liquid composition includes a transition metal.

42. The method of claim 41, wherein the transition metal is colloidal silver.

43. The method of claim 34, wherein the second liquid composition includes a peracid.
